(19) United States
(12) Patent Application Publication
(10) Pub. No.: US 2014/0084219 A1
(43) Pub. Date: Mar. 27, 2014

(54) DOPED MULTIWALLED CARBON NANOTUBE FIBERS AND METHODS OF MAKING THE SAME

(71) Applicants: Yao Zhao, Houston, TX (US); Jinquan Wei, Beijing (CN); Padraig G. Moloney, Boston, MA (US); Pulickel M. Ajayan, Houston, TX (US); Enrique V. Barrera, Houston, TX (US)

(72) Inventors: Yao Zhao, Houston, TX (US); Jinquan Wei, Beijing (CN); Padraig G. Moloney, Boston, MA (US); Pulickel M. Ajayan, Houston, TX (US); Enrique V. Barrera, Houston, TX (US)

(73) Assignee: William Marsh Rice University, Houston, TX (US)

(21) Appl. No.: 14/001,935

(22) PCT Filed: Feb. 28, 2012
(86) PCT No.: PCT/US12/26982

§ 371 Date: Dec. 5, 2013

Related U.S. Application Data
(60) Provisional application No. 61/447,305, filed on Feb. 28, 2011.
(60) Provisional application No. 61/449,309, filed on Mar. 4, 2011.

(51) Int. Cl. H01B 1/04; D02G 1/02

(52) U.S. Cl. CPC H01B 1/04; D02G 1/02; B82Y 30/00
USPC 252/506; 428/367; 57/200; 252/502; 252/500; 252/511; 57/362; 57/7; 977/752; 977/843

(57) ABSTRACT

In some embodiments, the present invention pertains to carbon nanotube fibers that include one or more fiber threads. In some embodiments, the fiber threads include doped multi-walled carbon nanotubes, such as doped double-walled carbon nanotubes. In some embodiments, the carbon nanotubes are functionalized with one or more functional groups. In some embodiments, the carbon nanotube fibers are doped with various dopants, such as iodine and antimony pentafluoride. In various embodiments, the carbon nanotube fibers of the present invention can include a plurality of intertwined fiber threads that are twisted in a parallel configuration with one another. In some embodiments, the carbon nanotube fibers include a plurality of fiber threads that are tied to one another in a serial configuration. In some embodiments, the carbon nanotube fibers of the present invention are also coated with one or more polymers. Additional embodiments of the present invention pertain to methods of making the aforementioned carbon nanotube fibers.

### CROSS-REFERENCE TO RELATED APPLICATIONS

This application claims priority to U.S. Provisional Patent Application Nos. 61/449,309, filed on Mar. 4, 2011; and 61/447,305, filed on Feb. 28, 2011. The entirety of the above-identified provisional applications are incorporated herein by reference.

### STATEMENT REGARDING FEDERALLY SPONSORED RESEARCH

This invention was made with government support under Grant No. DE-AC26-07NT42677, awarded by the U.S. Department of Energy. The government has certain rights in the invention.

### BACKGROUND OF THE INVENTION

Current carbon nanotube fibers have limitations in conductivity, resistivity, thermal stability, and current carrying capacity. Therefore, a need exists for the development of carbon nanotube fibers with improved electrical properties.

### BRIEF SUMMARY OF THE INVENTION

In some embodiments, the present invention pertains to carbon nanotube fibers that include one or more fiber threads. In some embodiments, the fiber threads include multi-walled carbon nanotubes, such as double-walled carbon nanotubes. In some embodiments, the multi-walled carbon nanotubes consist essentially of a single type of carbon nanotube, such as a double-walled carbon nanotube. In some embodiments, the carbon nanotubes are functionalized with one or more functional groups, such as carboxyl groups, carbonyl groups, oxides, alcohol groups, phenol groups, and combinations thereof.

In some embodiments, the carbon nanotube fibers are doped with dopants that include iodine, silver, chlorine, bromine, fluorine, gold, copper, aluminum, sodium, iron, antimony, arsenic, and combinations thereof. In some embodiments, the dopant is iodine. In some embodiments, the dopant is antimony pentafluoride.

The carbon nanotube fibers of the present invention can also have various arrangements and sizes. In some embodiments, the carbon nanotube fibers include a plurality of intertwined fiber threads that are twisted in a parallel configuration with one another. In some embodiments, the carbon nanotube fibers include a plurality of fiber threads that are tied to one another in a serial configuration. In various embodiments, the carbon nanotube fibers of the present invention have lengths that range from about 5 microns to about 100 microns. In various embodiments, the carbon nanotube fibers of the present invention have diameters that are less than about 10 μm. In some embodiments, the carbon nanotube fibers of the present invention are in the shape of cables or wires.

In some embodiments, the carbon nanotube fibers of the present invention are also coated with one or more polymers. In some embodiments, the polymers include at least one of polyethylenes, polypropylenes, poly(methyl methacrylate) (PMMA), polyvinyl alcohols (PVA), epoxide resins, and combinations thereof.

Additional embodiments of the present invention pertain to methods of making the aforementioned carbon nanotube fibers. Such methods include growing carbon nanotubes; purifying and optionally functionalizing the carbon nanotubes; aggregating the carbon nanotubes to form one or more fiber threads; and doping the carbon nanotubes with one or more dopants.

In various embodiments, the aforementioned steps may occur in different sequences and involve different variations. For instance, in some embodiments, the growing step occurs by chemical vapor deposition. In some embodiments, the purifying step and a functionalization step occur at the same time by exposure of the carbon nanotubes to an acidic solution, such as sulfuric acid. In some embodiments, the purifying step includes washing the carbon nanotubes with deionized water. In some embodiments, the aggregating step includes shrinking the multi-walled carbon nanotubes by exposure of the multi-walled carbon nanotubes to water.

In some embodiments, the doping step occurs after the aggregating step. In further embodiments, the doping step occurs during or before the growing step.

In further embodiments, the methods of the present invention also involve a step of linking the formed fiber threads to one another. In some embodiments, the linking involves twisting the fiber threads to one another in a parallel configuration. In some embodiments, the linking involves tying the fiber threads to one another in a serial configuration. In some embodiments, the linking leads to the formation of cables or wires. In further embodiments, the methods of the present invention also involve a step of coating the carbon nanotube fiber with a polymer.

The carbon nanotube fibers of the present invention provide advantageous electrical properties. For instance, in some embodiments, the carbon nanotube fibers of the present invention have high specific conductivity, low resistivity, thermal stability, and high current carrying capacity. Thus, the carbon nanotube fibers of the present invention can be used for various electrical applications, including use as conducting wires, motor windings and cables for various circuits.

### BRIEF DESCRIPTION OF THE FIGURES

FIG. 1 shows the growing of double-walled carbon nanotubes (DWCNTs). FIG. 1A provides an exemplary apparatus for growing DWCNTs and forming carbon nanotube fibers. FIG. 1B illustrates the initiation of the growth of DWCNTs by chemical vapor deposition (CVD) at a downstream end of a CVD tube. FIG. 1C illustrates the propagation of the growth of DWCNTs. FIG. 1D shows a picture of the grown DWCNTs.

FIG. 2 shows purified forms of DWCNTs. FIG. 2A shows DWCNTs in a flocculent form in water. FIG. 2B shows DWCNT bundles loosened up after soaking in 98% sulfuric acid.

FIG. 3 shows an image of formed DWCNT fibers.

FIG. 4 shows images of assembled DWCNT fibers. FIG. 4A shows an image of DWCNT fibers braided in a parallel configuration. FIG. 4B show an image of DWCNT fibers braided in a serial configuration.

FIG. 5 shows transmission electron microscopy (TEM) image of DWCNT bundles, in which DWCNTs are dominant and few walled carbon nanotubes (FWCNTs) are mixed. The average diameter of the DWCNTs is 2.3 nm with a narrow variation.

FIG. 6 is a scanning electron microscopy (SEM) image of a small piece of DWCNT film that was obtained after a sulfuric acid soaking step. DWCNTs have an alignment in the gas flow direction, which is marked by the white arrow.

FIG. 7 is an SEM image of densely packed DWCNTs. Within the fiber, the DWCNTs still retain the rough alignment succeeded from the film.

FIG. 8 is an x-ray photoelectron spectroscopy (XPS) spectrum of an iodine doped fiber. The peak at 285 ev is assigned to carbon. The double peaks at 625 ev and 640 ev correspond to iodine. The peak at 540 ev corresponds to oxygen. The atomic ratios of iodine, oxygen and carbon are 4%, 7% and 89%, respectively.

FIG. 9 shows thermal gravimetric analysis (TGA) curves of raw and iodine doped fibers.

FIG. 10 shows data relating to the elemental mapping of the iodine doped DWCNT films. FIG. 10A shows the carbon mapping of the DWCNT films. FIG. 10B shows the iodine mapping of the DWCNT films. FIG. 10C shows a TEM image of the iodine doped DWCNT film. FIG. 10D is an overlapping image of carbon and iodine mapping, in which carbon and iodine are marked by red and green, respectively.

FIG. 11 shows Raman spectra collected at three randomly chosen spots along a DWCNT fiber before and after iodine doping. The solid and dotted lines represent the spectra before and after iodine doping, respectively.

FIG. 12 shows reduced AC resistance as a function of frequency for un-doped and iodine doped DWCNT fibers.

FIG. 13 is a chart that compares the resistivity of pre-existing carbon nanotube fibers with the DWCNT fibers prepared in the present Application.

FIG. 14 is a graph illustrating resistivity as a function of fiber diameter for 34 raw DWCNT fibers. Each dot corresponds to one raw fiber.

FIG. 15 is a graph illustrating resistivity as a function of fiber diameter for iodine doped and raw DWCNT fibers. Each circled dot represents one iodine doped DWCNT fiber. Each square dot represents one raw DWCNT fiber.

FIG. 16 is a chart comparing the specific conductivity of a variety of metals with the specific conductivity of raw DWCNT fibers (R) and iodine doped DWCNT fibers (D). Rₗ and Dₗ denote the raw and doped fibers with the lowest resistivity, respectively. Rₐ and Dₐ denote the average value of the raw and doped fibers.

FIG. 17 illustrates a comparison in current carrying capacities between DWCNT fibers and copper wires for household use.

FIG. 18 provides an illustration of assembled DWCNT fibers utilized in a study.

FIG. 18A shows fiber 1 and fiber 2 being linked by a tie. FIG. 18B shows an SEM image of the tie. FIG. 18C is a more focused SEM image of the tie.

FIG. 19 is an SEM image of two parallel DWCNT fibers (fibers 3 and fiber 4) that were twisted into one for a study.

FIG. 20 summarizes studies relating to the effect of temperature on the resistance of iodine doped DWCNT fibers (fiber 5 and fiber 6). The main graph shows the resistance as a function of temperature for the fibers. The inset illustrates the two different data acquisition protocols applied for each fiber. Each dot represents the conditions, including the sequential time and the temperature for each data acquisition.

FIG. 21 shows the relative resistance of iodine doped DWCNT fibers and copper as a function of temperature.

FIG. 22 illustrates the application of iodine doped DWCNT fibers as a household circuit. FIG. 22A shows a braided iodine doped DWCNT fiber wire as a segment of a conductive media that is hooked with the household power supply and loaded with a light bulb (9 watts, 0.15 A, 120V). FIG. 22B shows the braided wire with a length of 8 cm in a zoom-in view. FIG. 22C shows an SEM image of the braided wire, which is composed of two fibers in a parallel assembly (fiber 1, diameter=50 microns; fiber 2, diameter=60 microns).

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Current carbon nanotube fibers have limitations in conductivity, resistivity, thermal stability, and current carrying capacity. Therefore, a need exists for the development of carbon nanotube fibers with improved electrical properties that could be effectively used for various electrical applications. The present invention addresses this need by providing carbon nanotube fibers with effective electrical properties, and methods of making them.

In some embodiments, the present invention provides carbon nanotube fibers with one or more fiber threads that include doped carbon nanotubes. In some embodiments, the present invention provides methods of making the carbon nanotube fibers by growing carbon nanotubes; purifying the carbon nanotubes; aggregating the carbon nanotubes; and doping the carbon nanotubes with one or more dopants.

Carbon Nanotube Fibers

The carbon nanotube fibers of the present invention generally refer to one or more fiber threads that include doped carbon nanotubes. In some embodiments, the carbon nanotube fibers may also be coated with a polymer. As set forth in more detail below, various carbon nanotubes, dopants, and polymers may be used in the carbon nanotube fibers of the present invention. Furthermore, the fiber threads in the carbon nanotube fibers may have various arrangements.

Carbon Nanotubes

Various carbon nanotubes may be utilized in the carbon nanotube fibers of the present invention. Non-limiting examples of suitable carbon nanotubes include single-walled carbon nanotubes (SWCNTs), double-walled carbon nanotubes (DWCNTs), multi-walled carbon nanotubes (MWCNTs), few-walled carbon nanotubes (FWCNTs), ultra-short carbon nanotubes, and combinations thereof.

In more specific embodiments, the carbon nanotube fibers of the present invention include DWCNTs. As set forth in more detail in the Examples below, Applicants have realized that various unique features of DWCNTs make them optimal materials for preparing carbon nanotube fibers with improved electrical properties. For instance, DWCNTs have long lengths of about several microns (or even longer), small diameters of about 2-3 nanometers, and a tendency to align in the direction of gas flow during growth. Furthermore, DWCNTs have a tendency to interconnect to one another by van der Waals interactions during growth. As a result, DWCNTs generally remain homogeneous and compact.

In more specific embodiments, the carbon nanotube fibers of the present invention consist essentially of a single type of carbon nanotube. For instance, in some embodiments, the carbon nanotube fibers of the present invention consist essentially of a single type of a multi-walled carbon nanotube, such as a DWCNT. Applicants envision that the use of a single type of carbon nanotube within a carbon nanotube fiber can further enhance the electrical properties of the carbon nanotube fibers.

Carbon Nanotube Modifications

In some embodiments, the carbon nanotubes used in the carbon nanotube fibers of the present invention are pristine carbon nanotubes. In some embodiments, the carbon nanotubes are functionalized with various functional groups. Non-limiting examples of functional groups include carboxyl groups, carbonyl groups, oxides, alcohol groups, phenol groups, aryl groups, and combinations thereof. In further embodiments, the carbon nanotubes of the present invention may include defective carbon nanotubes, such as carbon nanotubes with one or more side-wall holes or openings.

Dopants

In various embodiments, the carbon nanotube fibers of the present invention may also be doped with one or more dopants. Doped carbon nanotube fibers generally refer to fibers with carbon nanotubes that are associated with one or more dopants. In some embodiments, the dopants are endohedrally included in free spaces within carbon nanotubes. In some embodiments, dopants replace carbon atoms within the carbon nanotube structure. In some embodiments, the dopants are exohedrally incorporated between carbon nanotubes.

Non-limiting examples of suitable dopants include compounds or heteroatoms containing iodine, silver, chlorine, bromine, potassium, fluorine, gold, copper, aluminum, sodium, iron, boron, antimony, arsenic, silicon, sulfur, and combinations thereof. In some embodiments, the carbon nanotube fibers may be doped with one or more heteroatoms, such as AuCl₃ or BH₃. In some embodiments, the carbon nanotubes may be doped with an acid, such as sulfuric acid or nitric acid. In further embodiments, the carbon nanotube fibers of the present invention may be doped with electrons, holes, and combinations thereof.

In more specific embodiments, the carbon nanotube fibers of the present invention may be doped with arsenic pentafluoride (AsF₅), antimony pentafluoride (SbF₅), metal chlorides (e.g., FeCl₃ and/or CuCl₂), iodine, melamine, carboranes, aminoboranes, phosphines, aluminum hydroxides, silanes, polysilanes, polysiloxanes, sulfides, thiols, and combinations thereof.

In more specific embodiments, the carbon nanotube fibers of the present invention include iodine doped carbon nanotubes, such as iodine doped DWCNTs. As set forth in more detail in the Examples below, carbon nanotube fibers with iodine doped DWCNTs have improved electrical properties, including enhanced conductivity, enhanced resistivity, thermal resistance, and improved current carrying capacity.

In further embodiments, the carbon nanotube fibers of the present invention may be doped with SbF₅. As set forth in more detail in Applicants' co-pending patent applications, the intercalation of SbF₅ with carbon nanotubes can significantly enhance the electrical conductivity of the carbon nanotubes, such as by a factor of ten. See, e.g., Provisional Patent Application No. 61/447,305 and PCT Application No. PCT/US12/26949. In some embodiments, the carbon nanotube fibers of the present invention may be doped with iodine and SbF₅.

Polymer Coating

In some embodiments, the carbon nanotube fibers of the present invention may also be coated with one or more polymers. Non-limiting examples of polymers include polyethylenes, polypropylenes, poly(methyl methacrylate) (PMMA), polyvinyl alcohols (PVA), epoxide resins, and combinations thereof.

Fiber Thread Arrangements

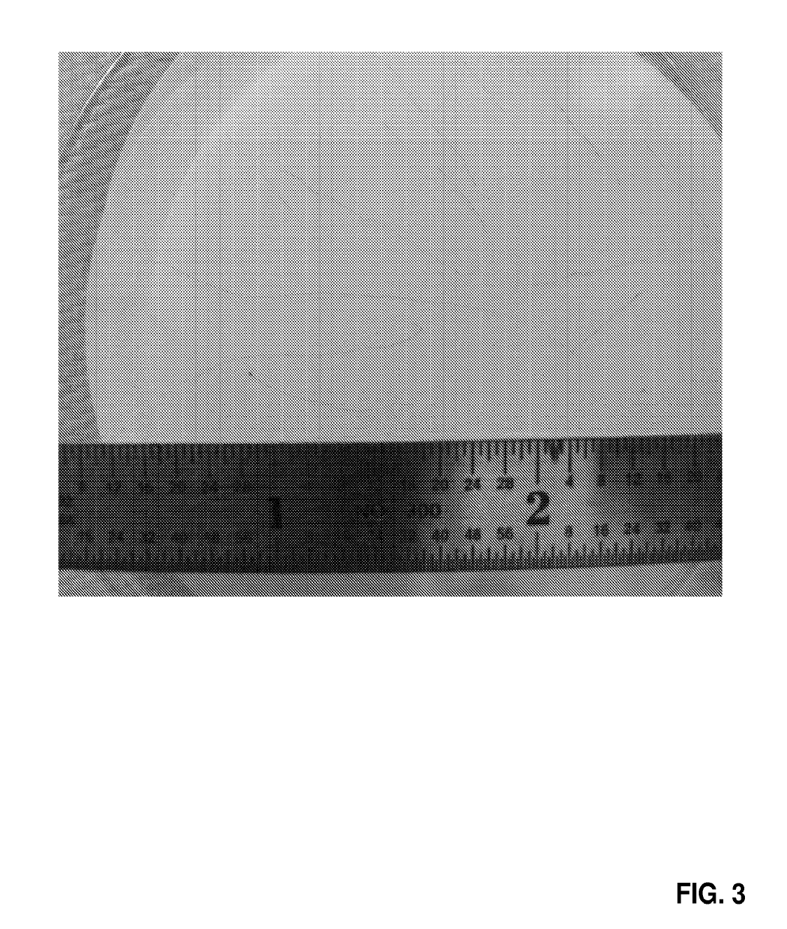

The fiber threads in the carbon nanotube fibers of the present invention may have various arrangements. In some embodiments, the carbon nanotube fibers include intertwined fiber threads that are twisted in a parallel configuration with one another. See, e.g., FIG. 4A. In some embodiments, the carbon nanotube fibers include fiber threads that are tied to one another in a serial configuration. See, e.g., FIG. 4B. In further embodiments, the carbon nanotube fibers of the present invention include fiber threads that are in parallel and serial configurations. In some embodiments, the fiber threads of the present invention may be arranged to form cables or wires.

Carbon Nanotube Fiber Sizes

The formed carbon nanotube fibers of the present invention have various lengths and diameters. In some embodiments, the carbon nanotube fibers of the present invention have lengths that range from about 5 microns to about 2 centimeters. In more specific embodiments, the carbon nanotube fibers of the present invention have lengths that range from about 5 microns to about 100 microns.

In some embodiments, the carbon nanotube fibers of the present invention have diameters that are less than about 10 μm. In some embodiments, the carbon nanotube fibers of the present invention have diameters of about 5 μm. In some embodiments, the carbon nanotube fibers of the present invention have double-walled carbon nanotubes with diameters that range from about 5 μm to about 3 nm.

As set forth in more detail in the Examples below, Applicants have found a size effect for a fibers' conductivity. In some embodiments, carbon nanotube fibers of a smaller diameter (e.g., 5 μm) have better conductivity.

Methods of Making Carbon Nanotube Fibers

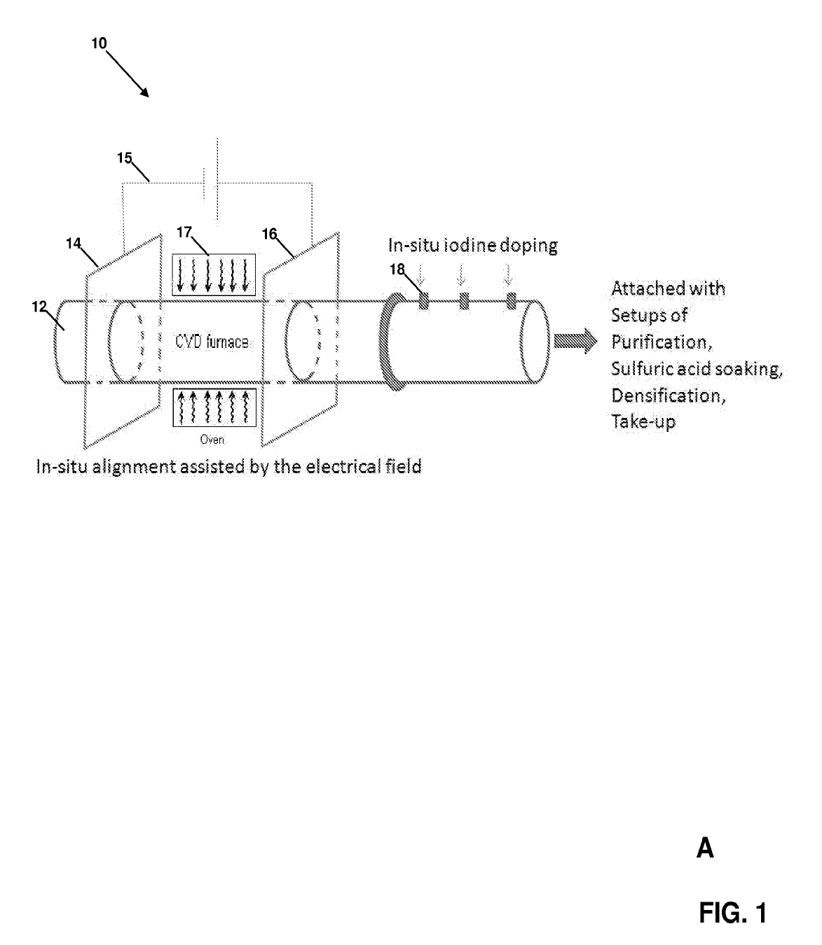

Additional embodiments of the present invention pertain to methods of making carbon nanotube fibers. A specific example of a method of forming carbon nanotube fibers is illustrated in FIG. 1A. In this example, Apparatus 10 is utilized to make iodine doped DWCNT fibers by a flow chemical vapor deposition (CVD) method. Apparatus 10 generally includes tube 12, electrode plates 14 and 16, circuit 15, oven 17, and apertures 18.

In operation, an AC or DC electric field is applied to tube 12 through electrode plates 14 and 16 and circuit 15 in order to align the carbon nanotubes during the growing process. Next, oven 17 is heated. Thereafter, a carbon source is added to tube 12 to lead to the growth of DWCNTs. The grown DWCNTs are then doped with iodine through apertures 18 as the DWCNTs migrate towards the end of tube 12. The collected iodine doped DWCNTs are then purified and functionalized by soaking in sulfuric acid. Thereafter, the DWCNTs are aggregated by shrinking in deionized water. As a result, iodine doped DWCNT fibers are formed.

The above-mentioned steps may occur in a continuous or discontinuous manner. In some embodiments, the process can become continuous by integrating the setup. For instance, as DWCNTs flow out from the CVD furnace, a purification setup, a sulfuric acid soaking bath, a densification bath, a doping chamber and a take-up facility can be connected sequentially.

More generally, the methods of making carbon nanotube fibers in the present invention include (1) growing carbon nanotubes; (2) purifying the carbon nanotubes; (3) optionally functionalizing the carbon nanotubes; (4) aggregating the carbon nanotubes to form one or more fiber threads; and (5) doping the multi-walled carbon nanotubes with one or more dopants. The methods of the present invention may also include a step of (6) coating the carbon nanotubes with one or more polymers. As set forth in more detail below, each of the aforementioned steps can have different variations. Furthermore, the above-mentioned steps may occur in different sequences or at the same time. Moreover, the aforementioned steps may occur in a continuous or discontinuous manner.

Growing

Various methods may be used to grow carbon nanotubes. In some embodiments, carbon nanotubes are grown by chemical vapor deposition (CVD). In some embodiments, carbon nanotubes are grown from a carbon source on a catalyst surface (e.g., polymer-based growth on a metal surface). In some embodiments, the carbon nanotubes are grown under an electric field. In some embodiments, the carbon nanotubes are grown while being heated.

Purifying

Various methods may also be used to purify the grown carbon nanotubes. In some embodiments, the purification step involves washing the carbon nanotubes with deionized water. In some embodiments, the purification step involves exposing the carbon nanotubes to an acid, such as sulfuric acid.

Functionalizing

Various methods may also be used to functionalize carbon nanotubes. For instance, in some embodiments, carbon nanotubes may be functionalized by exposure to an acidic solution. In some embodiments, the acidic solution is at least one of sulfuric acid, nitric acid, chlorosufonic acid, hydrochloric acid, and combinations thereof. In some embodiments, carbon nanotubes are functionalized by exposure to hydrogen peroxide. In more specific embodiments, the carbon nanotubes are functionalized by exposing the multi-walled carbon nanotubes to sulfuric acid. In further embodiments, the purifying step and the functionalization step occur at the same time by exposing the multi-walled carbon nanotubes to an acidic solution. In various embodiments, the functionalizing agents may be in a liquid state, a gaseous state or combinations of such states.

Aggregating

Various methods may also be used to aggregate carbon nanotubes in order to form one or more fiber threads. In some embodiments, the aggregating involves shrinking the carbon nanotubes. In some embodiments, the aggregating occurs by exposure of the carbon nanotubes to water.

Doping

Various methods may also be used to dope carbon nanotube fibers with one or more dopants. In some embodiments, the doping occurs by sputtering or spraying one or more doping agents onto carbon nanotubes. In some embodiments, the doping can also occur by chemical vapor deposition.

In some embodiments, the doping occurs after the aggregating step that produces the carbon nanotube fibers. In some embodiments, the doping occurs in situ during and/or after the carbon nanotube growing step. In further embodiments, the doping may occur in situ as well as after the formation of the carbon nanotube fibers.

In more specific embodiments, the carbon nanotubes may be doped with SbF₅. Non-limiting examples of methods of doping carbon nanotubes with SbF₅ are disclosed in Applicant's co-pending Provisional Patent Application No. 61/447,305 and PCT Application No. PCT/US12/26949.

Polymer Coating

Various methods may also be utilized to coat carbon nanotubes with polymers. In some embodiments, polymers may be applied to carbon nanotubes by spray coating, dip coating, immersion of carbon nanotubes into melted polymers, and combinations of such methods. In further embodiments, polymers may be applied to carbon nanotubes by evaporation, sputtering, chemical vapor deposition (CVD), inkjet printing, gravure printing, painting, photolithography, electron-beam lithography, soft lithography, stamping, embossing, patterning, spraying and combinations of such methods.

Linking of Fiber Threads

Once the carbon nanotube fibers are formed, various methods may also be used to link the formed fiber threads to one another. In some embodiments, the formed fiber threads may be linked to one another by twisting the fiber threads with one another in a parallel configuration. In some embodiments, the linking may include tying the fiber threads to one another in a serial configuration.

Various methods may be used to tie or twist fiber threads. In some embodiments, a micromanipulator may be used to link fiber threads. In some embodiments, traditional weaving techniques that are used in the textile industry may be used to link the fiber threads. In some embodiments, the fiber threads may be linked to form cables or wires.

Advantages

The carbon nanotube fibers of the present invention provide various advantageous electrical properties, including high specific conductivity, low resistivity, high current carrying capacity, and thermal stability. In some embodiments, the carbon nanotube fibers of the present invention provide electrical properties that are comparable or better than the electrical properties of conventional metal-based wires, such as copper wires or aluminum wires.

For instance, in some embodiments, the carbon nanotube fibers of the present invention have current carrying capacities that are at least about 10⁴ A/cm² to about 10⁵ A/cm². In some embodiments, the carbon nanotube fibers of the present invention also have a resistivity of less than about 0.2 m.Ω.cm. In more specific embodiments, the carbon nanotube fibers of the present invention have a resistivity of less than about 0.05 m.Ω.cm. In further embodiments, the carbon nanotube fibers of the present invention have a resistivity of about 0.0155 m.Ω.cm. In further embodiments, the carbon nanotube fibers of the present invention have a resistivity that ranges from about 0.01 m.Ω.cm to about 0.03 m.Ω.cm. In some embodiments, the carbon nanotube fibers of the present invention provide less resistance variation at different temperatures.

Applications

The carbon nanotube fibers of the present invention provide numerous applications. For instance, the carbon nanotube fibers of the present invention can be assembled into one dimensional, two dimensional or even three dimensional macroscopic engineering components. Such structures could in turn be used as conducting wires, cables, batteries, reinforcement fabrics in composites, thermal conductors, microwave absorption materials, motor windings, and components in energy harvesting or conversion systems. In more specific embodiments, the carbon nanotube fibers of the present invention are utilized as conducing wires in household circuits, such as lamps and light bulbs. In further embodiments, the carbon nanotube fibers of the present invention are utilized for AC electricity transmission, RF signal transmission or data transmission for the internet.

The application of the carbon nanotube fibers of the present invention may also vary with the type of assembly utilized. For instance, carbon nanotube fibers assembled in a parallel (i.e., twisted) configuration have suitable thicknesses that could be utilized for high power applications. Likewise, carbon nanotube fibers that are linked to one another in a serial configuration may be suitable for use as conducing wires or cables in various circuits, such as household circuits.

### ADDITIONAL EMBODIMENTS

Reference will now be made to more specific embodiments of the present disclosure and experimental results that provide support for such embodiments. However, Applicants note that the disclosure below is for exemplary purposes only and is not intended to limit the scope of the claimed invention in any way.

The Examples below pertain to a process for making DWCNT fibers. The process includes DWCNT growth, purification, functionalization by soaking in sulfuric acid, fiber manufacture, fiber assembly and conditioning steps.

### Example 1

### DWCNT Growth

In this Example, DWCNTs are grown by a chemical vapor deposition (CVD) method, as illustrated in FIG. 1A. FIG. 1B shows that DWCNTs are flowing out from the high temperature reaction region to the downstream end of the tube. The DWCNT networks macroscopically appear like a stocking with a thin wall. The so-called stocking wall is marked by the arrow in FIG. 1B, which shows DWCNTs continuously flowing out like a thin-walled stocking.

As the growth continues, DWCNTs accumulate at the downstream end, as shown in FIG. 1C. The cone structure is composed of several layers of DWCNT films converged at the left hand side. If a take-up system is attached at the downstream end, the DWCNTs can be continuously pulled out from the furnace and the fibers could be continuously prepared.

After the furnace cools down, the fluffy multilayered cone shrinks into a relatively more dense form, as shown in FIG. 1D. As collected from the furnace, the DWCNT bundle contains catalysts.

### Example 2

### DWCNT Purification and Functionalization

The DWCNTs grown in Example 1 contain catalysts. It was found that impurities cause degradation in conductivity. Therefore, we purified DWCNTs before making them into fibers. The DWCNTs were first oxidized by heating the raw macroscopic DWCNT bundle in air at 400° C. for 1 hour. The oxidization treatment can attach oxidized functional groups to nanotubes and make DWCNTs be of a better wettability with water. Next, the oxidized DWCNTs were soaked into a 30% hydrogen peroxide solution for 72 hours. This soaking process can crack the amorphous carbon and make the catalysts dissociate from the carbon nanotubes. Afterward, the DWCNTs were transferred into a 37% hydrogen chloride solution and soaked for another 24 hours. Then, the DWCNTs as received from the previous procedure were washed by DI water until they became neutralized. After the purification, the catalyst weight percentage was below 1%.

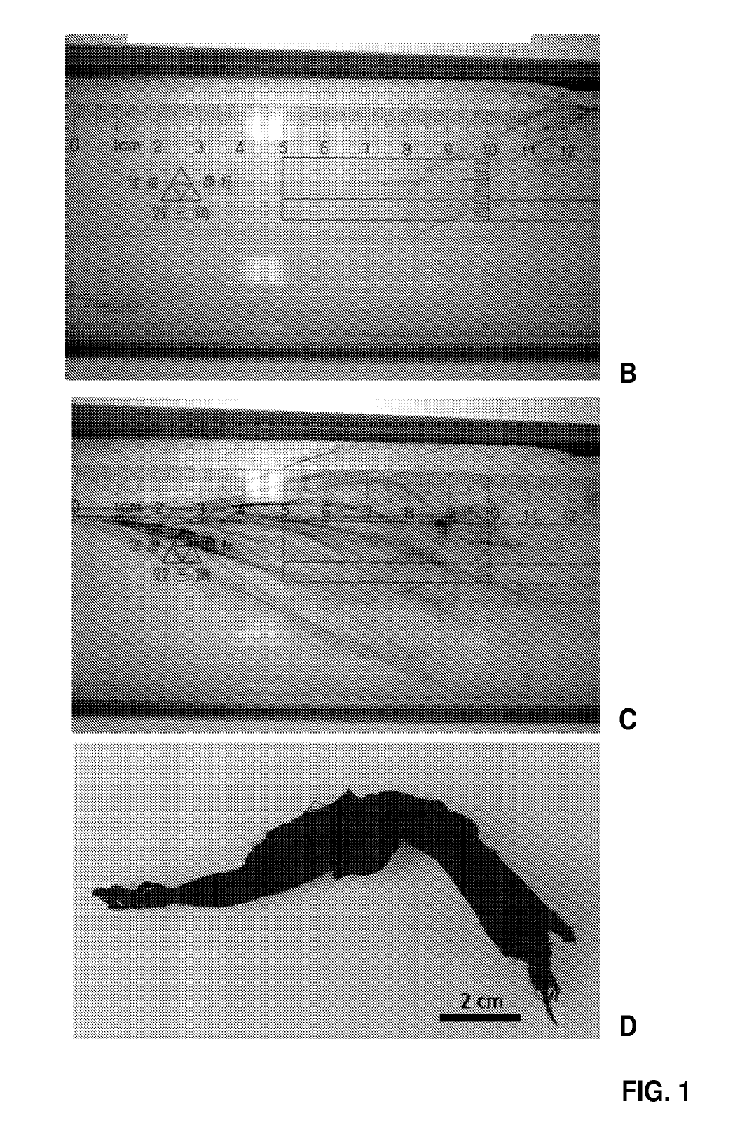

FIG. 2 shows the purified DWCNTs in water. The purified DWCNTs have much better wettability with water than the raw DWCNTs because functional groups were attached on the DWCNT surface by purification.

### Example 3

### Soaking of DWCNTs

The purified DWCNTs in water are in a bundled form because of van der Waals interactions between the carbon nanotubes. The diameter of the fibers is determined by how much DWCNTs would be used to make the fiber. If a larger or thicker film is peeled off from the bundle, a larger fiber would be prepared in the following steps. In our experiments, fibers of a variety of diameters varying from 5 microns up to 100 microns were prepared. It is found that fibers of a smaller diameter have a better conductivity. It is relatively easy to peel off a thick or large piece of film from the DWCNT bundle as produced and purified materials. The large films will result in fibers of diameter above 20 microns. To peel off a small piece of film to make a fiber of diameter of about 20 microns, the bundle needs to be spread. We found that DWCNT bundles can be loosened up and spread into thin films after they are soaked in 98% sulfuric acid for 24 hours. After the soaking treatment, the DWCNTs have a form as shown in FIG. 2A. From the thin film, we can peel off a small ribbon. As shown in FIG. 2B, two pieces of thin film peeled off from the macroscopic bundle. The fiber of about 5 microns in diameter was produced by the even smaller ribbon peeled off from these thin films.

### Example 4

### DWCNT Fiber Formation

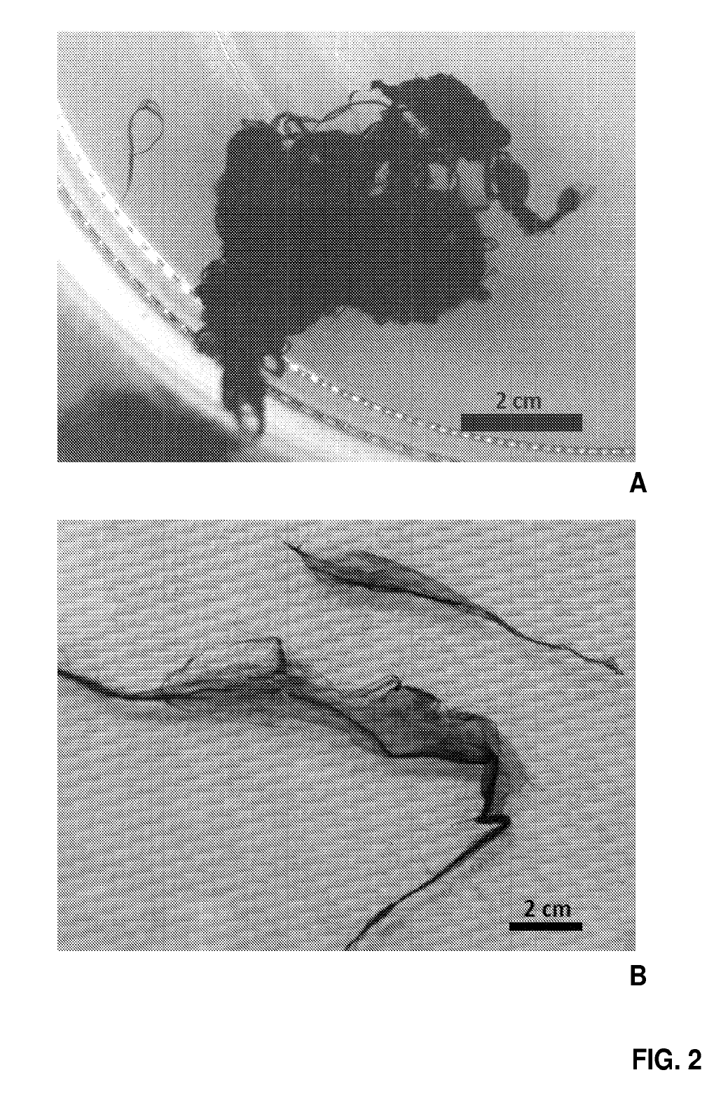

When the small DWCNT ribbon was taken out from the sulfuric acid solution in Example 3, the ribbon would agglomerate into a spherical particle because the surface tension caused by the residual sulfuric acid is isotropic. To retain the length in the long axis direction of the ribbon, we applied pulling forces on the two ends of the belt to counteract the tension force from the sulfuric acid when the ribbon was taken out of the sulfuric acid solution. Then, the ribbon was dipped into the DI water to wash out the residual acid. Afterward, the ribbon was taken out of the water. Along with the water evaporation process, the ribbon shrinks into the fiber as shown in FIG. 3. Without being bound by theory, it is envisioned that the shrinking is a synergistic effect of van der Waals forces between tubes and surface tension force from the water. In the step of shrinking, other solutions such as ethanol, acetone and hexane also work. Microscopically, the original loose DWCNT networks densify into much more dense fiber in the shrinking step.

As also shown in FIG. 3, the fibers have a variety of lengths. The fiber length is determined by the length of DWCNT ribbons taken from the macroscopic bundle. The growth can be adjusted into a continuous process. DWCNT bundles and fibers of desired lengths can then be prepared.

### Example 5

### DWCNT Fiber Assembly

We have developed two types of fiber assemblies: parallel configurations and serial configurations. By the parallel assembly, we can make a thicker fiber which can load utilities of high power. By the serial assembly, we can link several short fibers into a long one, which can be used as a conducing wire in the household circuit. Assembly is the key technique for bridging the gap between unique properties of nano or micro size materials and taking advantage of these properties in the macroscopic engineering components. We have developed parallel and serial assemblies for building engineering conducting wires from the DWCNT fibers.

FIGS. 4A and 4B show that fibers are assembled in a parallel and serial configuration, respectively. As shown in FIG. 4A, two fibers are braided in a parallel configuration. A fiber of an arbitrary diameter can be assembled from several smaller fibers in the parallel configuration. As shown in FIG. 4B, two fibers are serially connected by a tie. The serial connection enables the fibers to be assembled into one with an arbitrary length. The inset shows the way of making the tie. Several other ways of making ties are also applicable for connecting the fibers. Traditional kneading and braiding methods applied in the textile industry is also adaptable to DWCNT fiber assembly.

### Example 6

### DWCNT Fiber Doping

We found that iodine doping is effective for improving the conductivity of the raw DWCNT fibers. The iodine doping was conducted by placing the raw DWCNT fibers in the iodine vapor (the iodine vapor concentration in the chamber is 0.2 mol/L) at 200° C. for 10 hrs.

### Example 7

### DWCNT Fiber Characterization

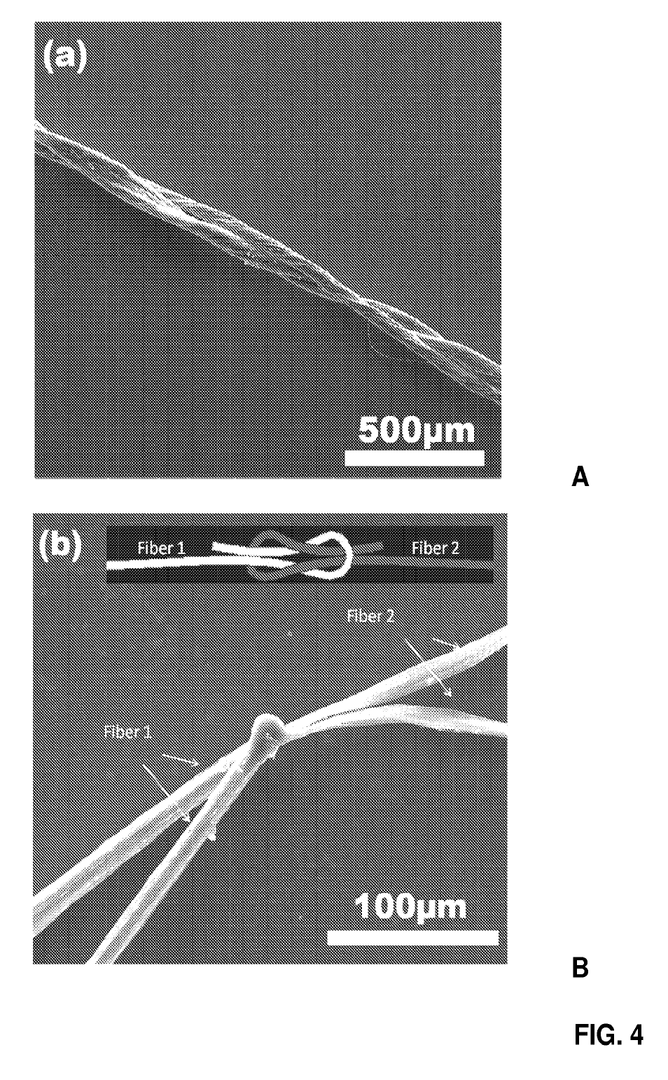

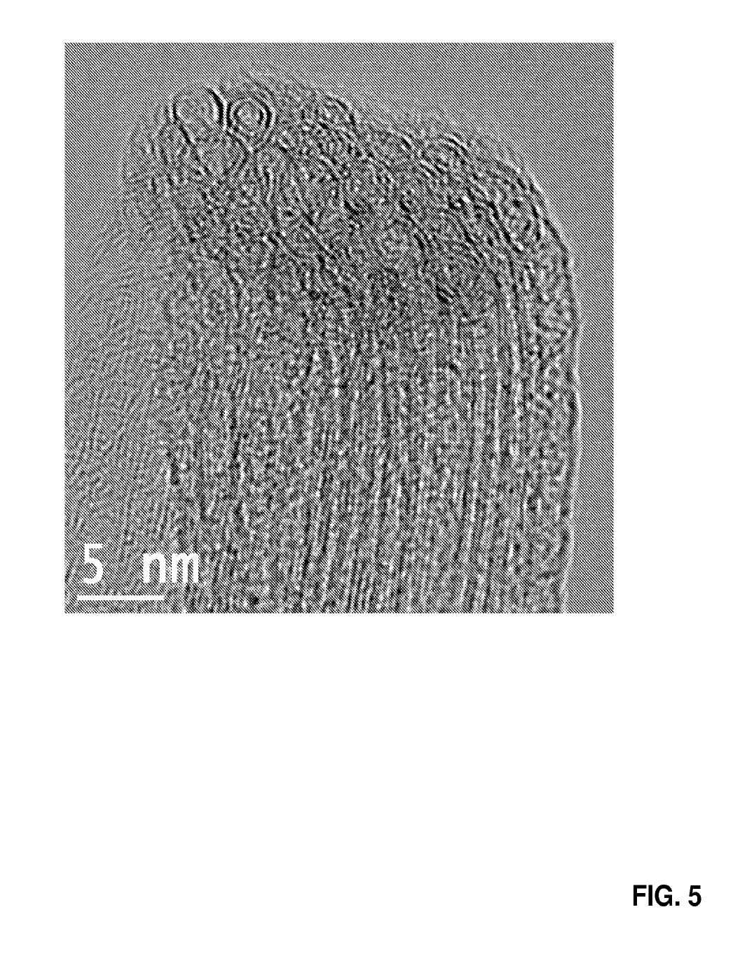

The DWCNTs in the preceding Examples are mixtures of DWCNTs and few-walled carbon nanotubes (FWCNTs), as shown in FIG. 5. The DWCNTs have an average diameter of 2.3 nm with a very narrow diameter distribution. We found that most of the DWCNTs are several microns long by tracking DWCNTs from their one end to the other end under TEM. The SEM image shown in FIG. 6 illustrates that the grown DWCNTs had an alignment in the gas flow direction. Meanwhile, the DWCNT networks were constructed by the natural interconnections during the growth process.

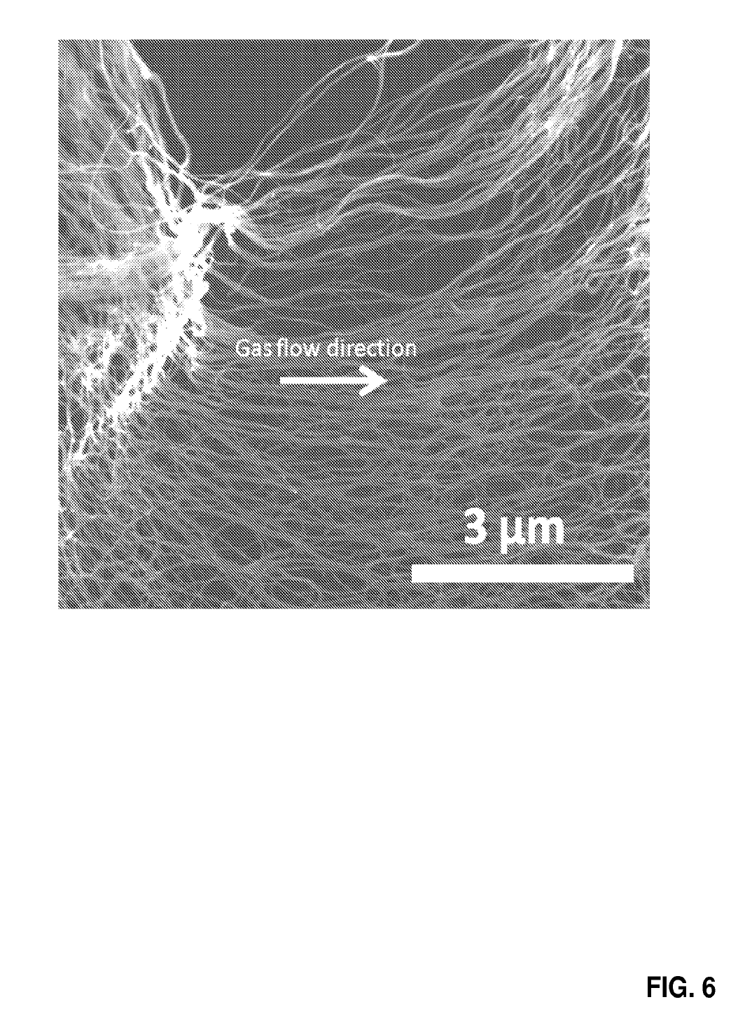

In the fiber, DWCNTs are much more densely packed than how they are in the film, as shown in FIG. 7. The fiber was shrunk from the film. Without being bound by theory, it is envisioned that the shrinking is a result of the synergistic effect of the tension force from the evaporated solution and van der Waals interactions between tubes. These two forces both are symmetric about the central long axis of the fiber. Therefore, the film shrunk into an approximately cylindrical structure. In the calculations of electrical properties, we assumed that the fibers have a circular cross section.

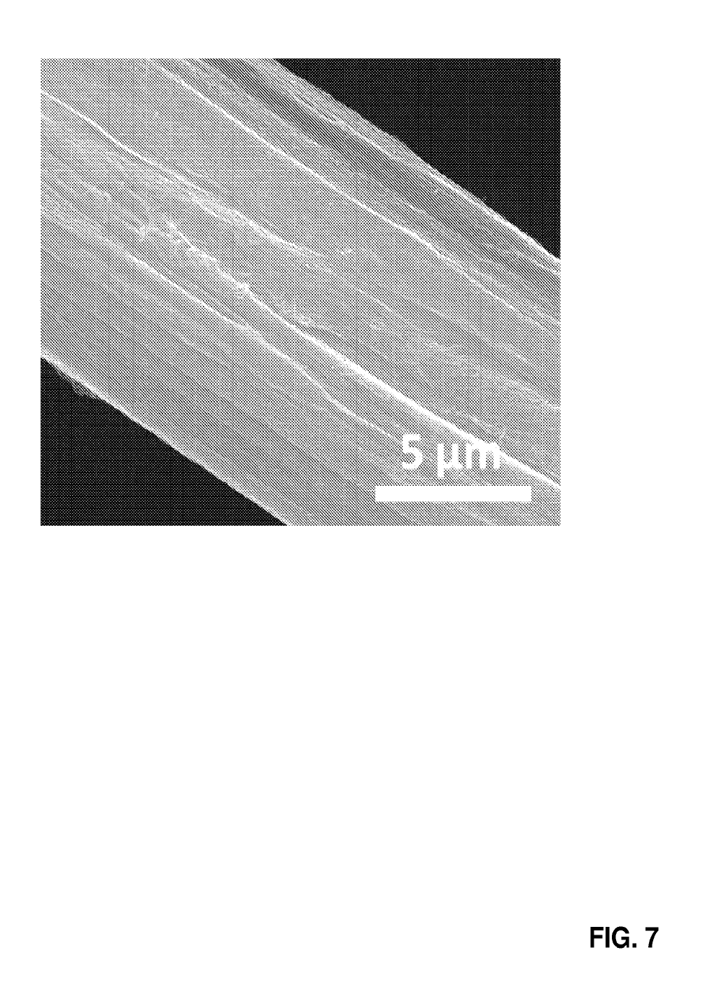

The elemental composition for the fibers was characterized by x-ray photoelectron spectroscopy (XPS). FIG. 8 shows the XPS of the iodine doped fiber. From the elemental analysis, it is found the atomic ratio of iodine, oxygen and carbon are 4%, 7% and 89%, respectively. From the atomic ratio, we can calculate the weight percentage of iodine as 15.2%, which is consistent with the result obtained by thermal gravimetric analysis (TGA). The oxygen is from the oxidized functional groups introduced in the purification step.

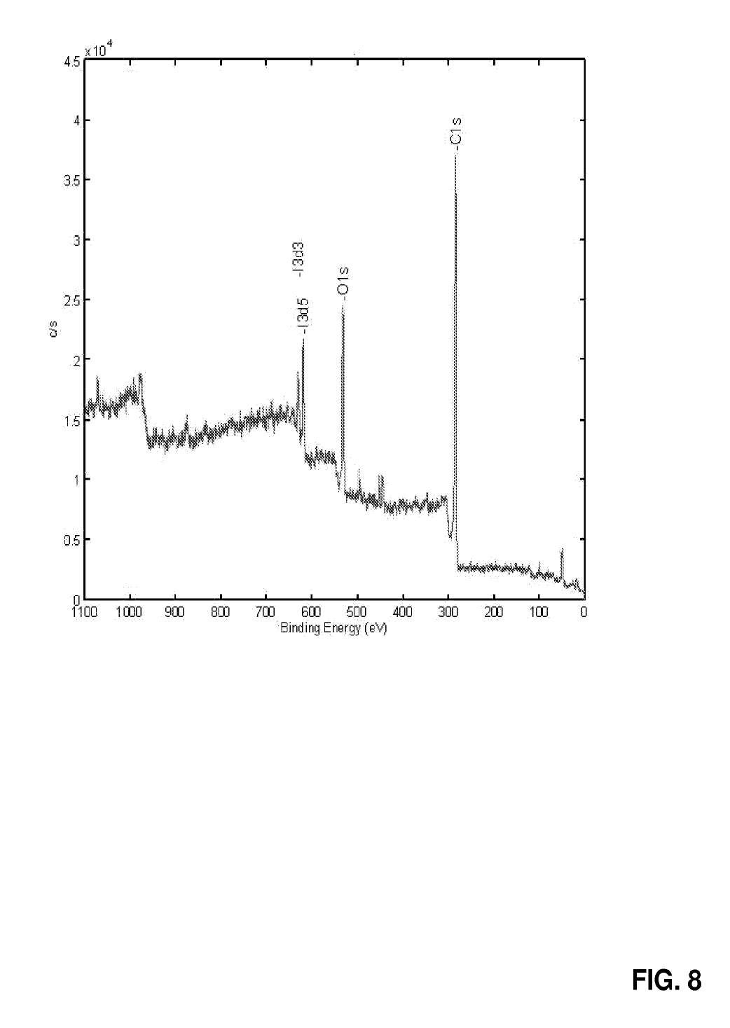

FIG. 9 shows thermal gravimetric analysis (TGA) curves of raw and iodine doped fibers. The iodine doped fiber started to lose weight at 75° C. The weight stabilized at 175° C. The first weight loss step was caused by the evaporation of iodine, which took 15.8% of the total weight. The second weight loss step occurred at 580° C., which corresponded to the burning of carbon nanotubes. The residual weight was less than 1% of the original weight. It indicated that most catalysts were removed. For the raw fiber, there was only one weight loss step, which initiated at 580° C. and ended at 700° C. Without being bound by theory, it is envisioned that the weight loss was due to the burning of the nanotubes.

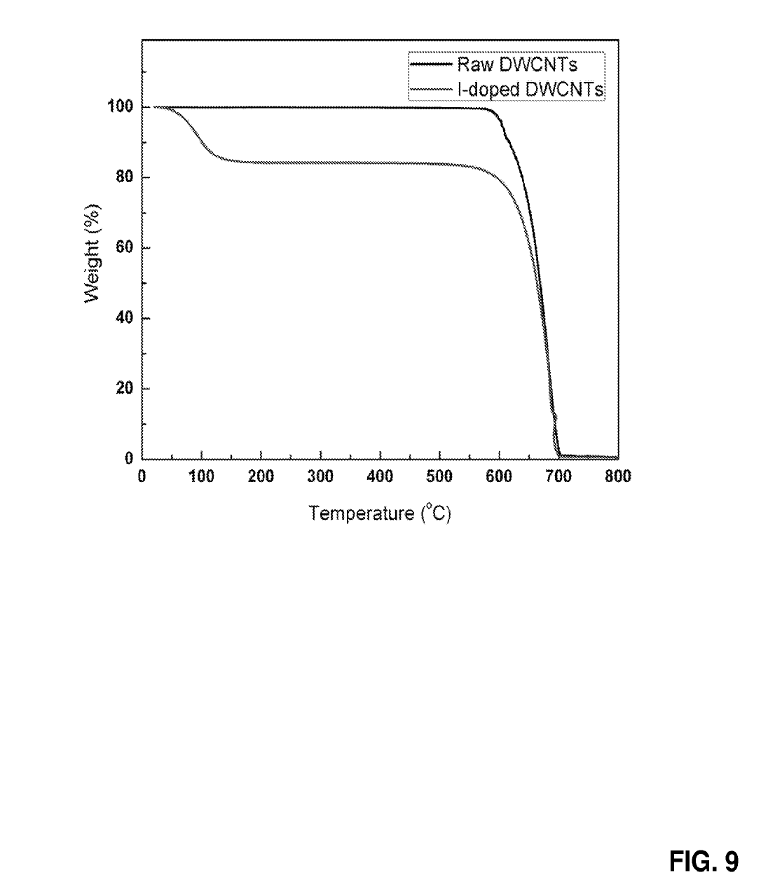

Elemental mapping was conducted on iodine film to understand the iodine and carbon distributions. Since an iodine doped fiber is too thick to be characterized by TEM, an iodine doped film was prepared under the same doping conditions and characterized by TEM. FIGS. 10A and 10B show the carbon and iodine mapping, respectively. The location of carbon and iodine is consistent. This indicates that iodine atoms are homogeneously doped on the carbon nanotubes. FIG. 10C shows the iodine doped DWCNTs. The surface is relatively rough compared to the raw DWCNTs. We proposed that the roughness is caused by the iodine atoms adsorbed on the DWCNT surface. FIG. 10D is the overlapping image of iodine and carbon mapping images.

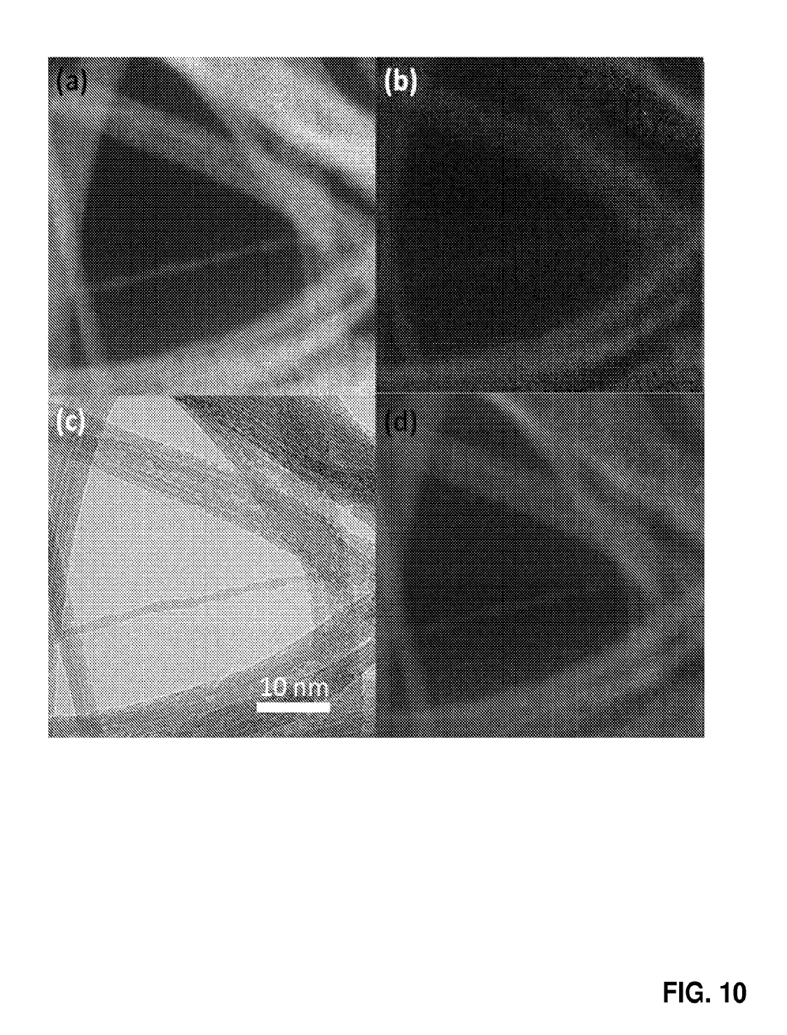

FIG. 11 shows the Raman spectroscopies collected at three different spots (the three spots were chosen randomly) on the fiber before and after the iodine doping. It was found that Raman spectra at the three different spots are similar. This finding supports the observation from the TEM that iodine doping is uniform along the fiber axial direction. Due to the uniformity, Raman spectra collected at different spots are indistinguishable. Comparing the spectra before and after iodine doping, we found that the peak at 153 cm⁻¹ becomes pronounced after the doping. Without being bound by theory, it is envisioned that the short-range periodicity is disturbed by the doping, and the high wave number mode corresponding to the short-range periodicity is suppressed. On the contrary, the low wave number mode corresponding to the long periodicity becomes pronounced.

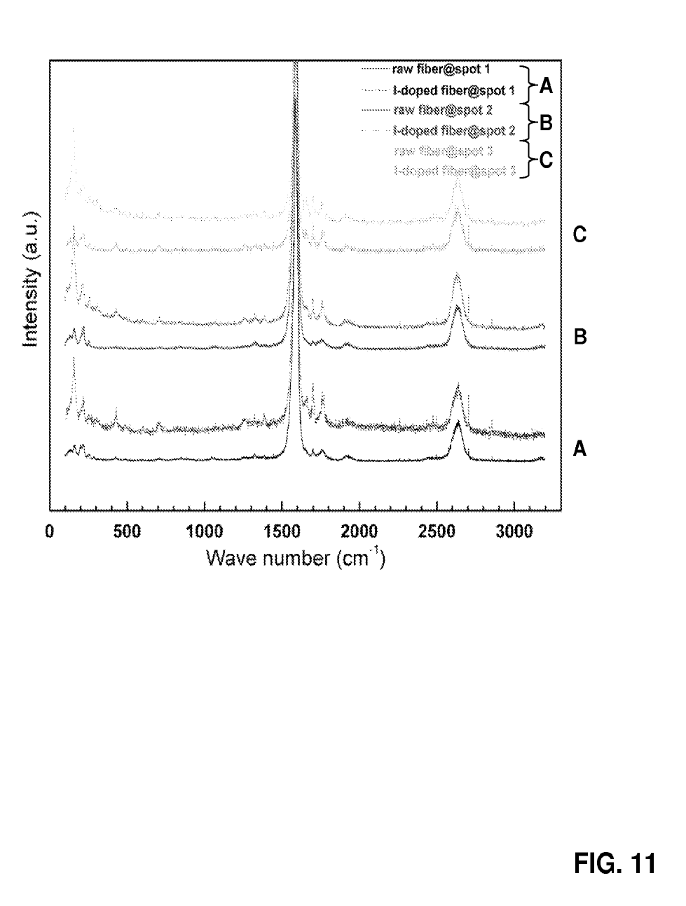

Furthermore, as shown in FIG. 12, it was observed that the resistivity of both the iodine doped DWCNT fibers and un-doped DWCNT fibers decreased as the frequency increased. Without being bound by theory, such results indicate that the high frequency signal transmitted through the DWCNT cable would not attenuate like it does for metals. This unique feature can open a wide range of applications for iodine doped and raw DWCNT wires and cables. Exemplary applications include AC electricity transmission, RF signal transmission, or data transmission for the internet. The signal transmission lines of traditional metals such as copper and aluminum experience severe signal attenuations at high frequency, particularly above Mega Hz. This signal attenuation is due to the resistivity increase as the frequency increases.

### Example 8

### Electrical Properties of DWCNT Fibers

In this Example, the electrical properties of DWCNT fibers are described in several aspects, including resistivity, specific conductivity and current carrying capacity. In addition, several factors that affect the electrical properties of the fibers are discussed. Such factors include fiber size, doping, temperature and assembly.

Resistivity

Fabrication of macroscopic carbon nanotube fibers has been studied for several years. Theoretically, the fibers of pure metallic carbon nanotubes can have resistivities lower than that of copper. In practice, the lowest resistivity achieved so far in the macroscopic fiber system is still several orders larger than the theoretically predicted value. Table 1 summarizes these findings.

The lowest reported resistivity of macroscopic carbon nanotube fiber systems as reported up to date is 0.2 mΩ.cm. The resistivities of the DWCNT fibers prepared in our current research is lower than any of the reported resistivity values. The resistivity of the DWCNT fibers ranges from about 0.059 mΩ.cm to an average resistivity of about 0.096 mΩ.cm. The variation of the resistivity for the fibers of a diameter larger than 10 microns is large. To exclude the influence from the outliers of a diameter larger than 10 microns, the average resistivity is calculated exclusively based on the fibers with a diameter smaller than 10 microns.

Furthermore, iodine doping is effective in improving a fiber's conductivity. Among 15 iodine doped DWCNT fibers, the minimum resistivity is 0.0155 mΩ.cm, and the average resistivity is 0.043 mΩ.cm. Without being bound by theory, it is envisioned that the exceptionally low resistivity of our DWCNT fibers can be due to an accumulative contribution from every step in processing.

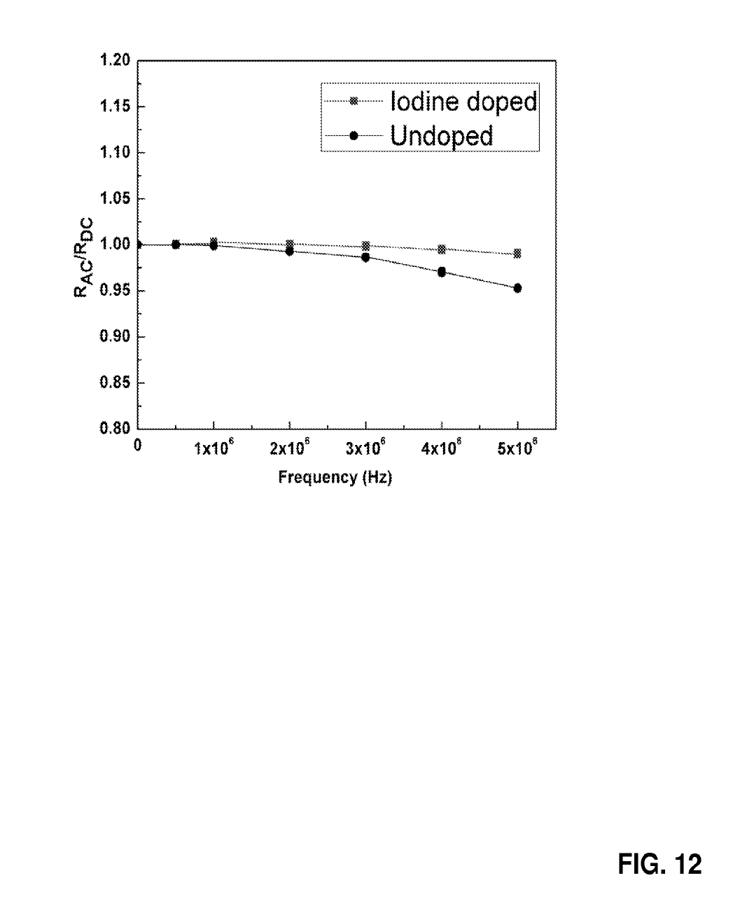

In particular, it is envisioned that three factors play roles in the low resistivity of the DWCNT fibers. First, the DWCNTs used in making the fibers have many unique features, such as a small diameter of 2-3 nanometers, a narrow size distribution, a large length, and in-situ interconnections and alignments. Second, due to the relatively small diameters, the packing density is high and free of voids when the fiber diameter is down to sub-10 microns. Third, the iodine doping increases the charge carrier density, and hence lowers the fiber's resistivity. FIG. 13 shows a comparison in resistivity among various carbon nanotube fibers.

TABLE 1
The resistivity of carbon nanotube fibers published in major articles.

| | CNT characteristics | | | | Electrical |
|---|---|---|---|---|---|
| | | Length | | | resistivity |
| Technique | Type | (Microns) | Diameter (nm) | Comments | (m Ω · cm) |
| Surfactant | SWNT | sub micron | ~1 | annealed | 10 |
| dispersion | | | | | |
| coagulated in PVA- | | | | | |
| water | | | | | |
| Surfactant | SWNT | sub micron | ~1 | as-spun | 150 |
| dispersion | | | | | |
| coagulated in | | | | | |
| ethanol/glycerol | | | | | |
| Surfactant | SWNT | sub micron | ~1 | as-spun | 150 |
| dispersion | | | | | |
| coagulated in acid or | | | | | |
| base | | | | | |
| Sulfuric acid | SWNT | sub micron | ~1 | annealed | 0.2 |
| dispersion | | | | | |
| coagulated in water | | | | | |
| Withdraw from the | SWNT | N/A | N/A | as-withdraw | 0.33 |
| gel | grown by | | | | |
| | arc | | | | |
| | discharge | | | | |
| CVD spinning | DWNT | N/A | 8-10 | as-spun | 0.2 |
| Vertical-grown CNT | MWNT | 100 | 10 | twisted | 3.3 |
| array spinning | MWNT | 650 | 10 | un-twisted | 5.8 |
| | | | | twisted | 2.4 |
| | DWNT | 1000 | 7 | twisted | 1.68 |
| | MWNT | N/A | N/A | twisted | 2.4 |
| | | | | coated with 5 wt | 1.1 |
| | | | | % PVA | |

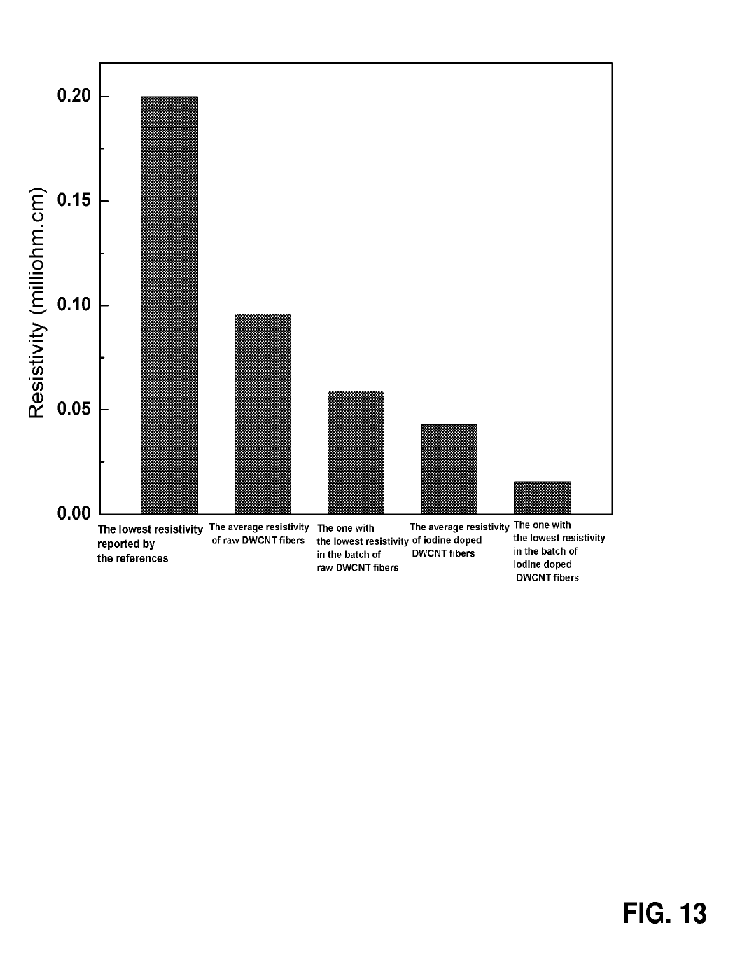

FIG. 14 is a graph illustrating resistivity as a function of diameter for 34 raw DWCNT fibers. Each dot corresponds to one raw fiber. These results indicate that fibers with diameters larger than 10 microns have a larger resistivity than fibers with diameters of less than 10 microns. It is envisioned that the size effect is due to the fact that voids are less possibly introduced into the smaller fibers during the fabrication process.

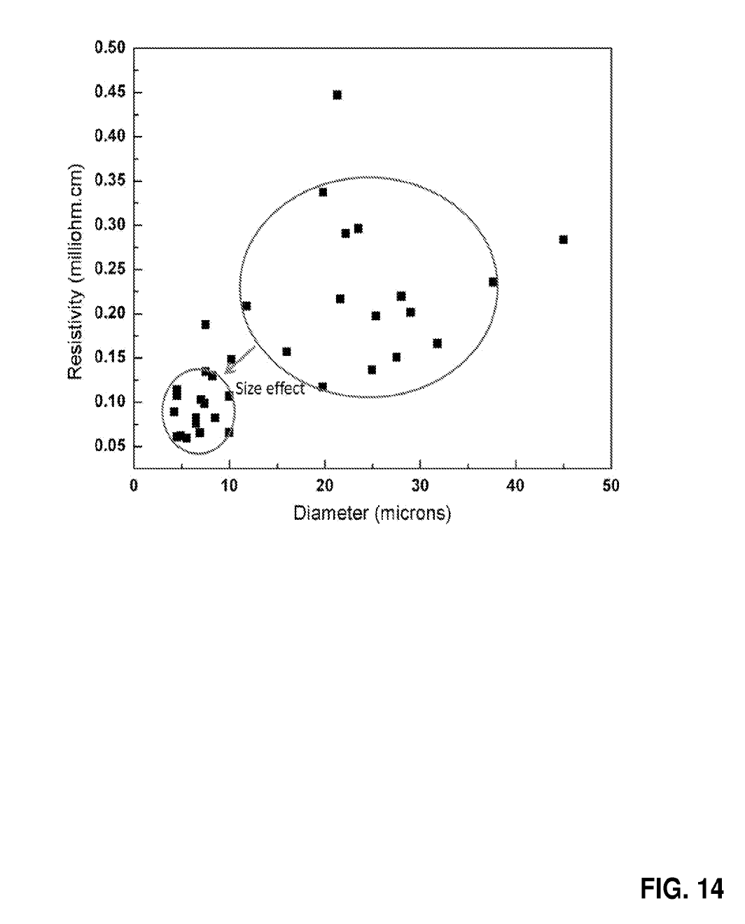

FIG. 15 shows a downward movement in resistivity as DWCNT fibers are doped with iodine. Based on TEM image and Raman characterization, it has been observed that iodine atoms are uniformly doped on the carbon nanotubes. The iodine atoms easily ionize when they are adsorbed on DWCNTs. Hence, the charge carrier density is increased.

Specific Conductivity

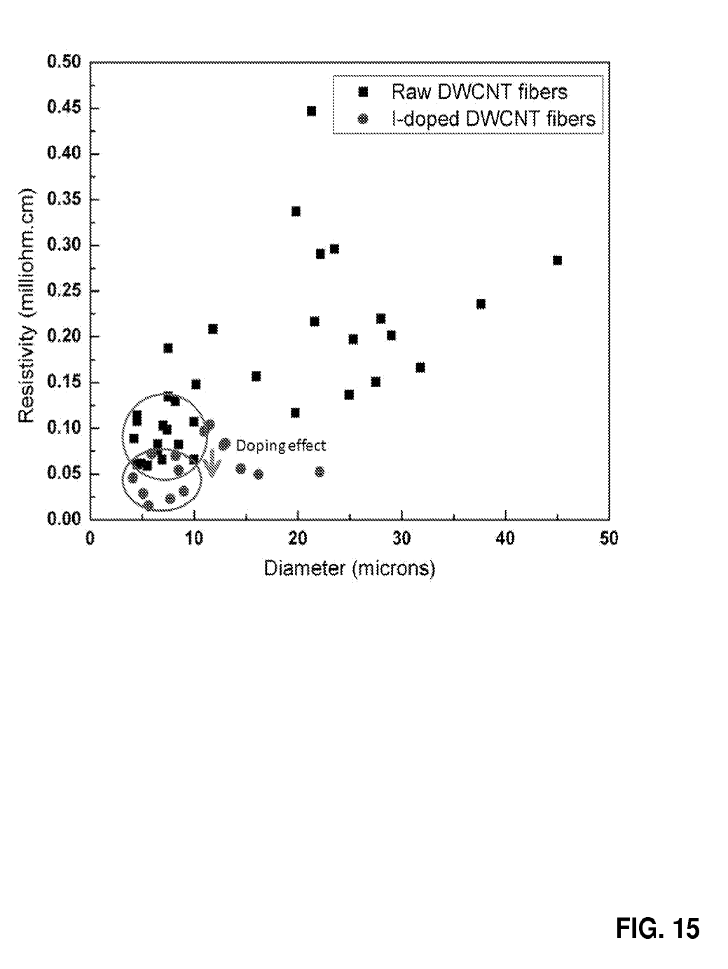

Specific conductivity defined by the ratio of conductivity to density is one of the major parameters in evaluating the conductive materials applied in the aerospace industry. Although the DWCNT fibers are not as conductive as metals, the density is much lower than metals. The raw DWCNT fibers have an average density of 0.28 g/cm³. After the iodine doping, the doped fiber has an average density of 0.33 g/cm³. In terms of the specific conductivity, the raw and doped DWCNT fibers are comparable with metals. See, e.g., FIG. 16. In the batch of iodine doped fibers, one of the fibers has a specific conductivity of 1.96*10⁴ S.m²/kg. This conductivity is higher than that of aluminum, but slightly lower than sodium, which has a specific conductivity of 2.16*10⁴ S.m²/kg.

Current Carrying Capacity

Current carrying capacity is a parameter that measures the maximum current that can be passed through a cross sectional area of a conducting media. A single MWCNT usually has a high current carrying capacity of about 10⁹-10¹⁰ A/cm². However, the current carrying capacities of macroscopic carbon nanotube fibers are much lower. Recently, a macroscopic SWCNT fiber was found to have a current carrying capacity of 10⁵ A/cm².

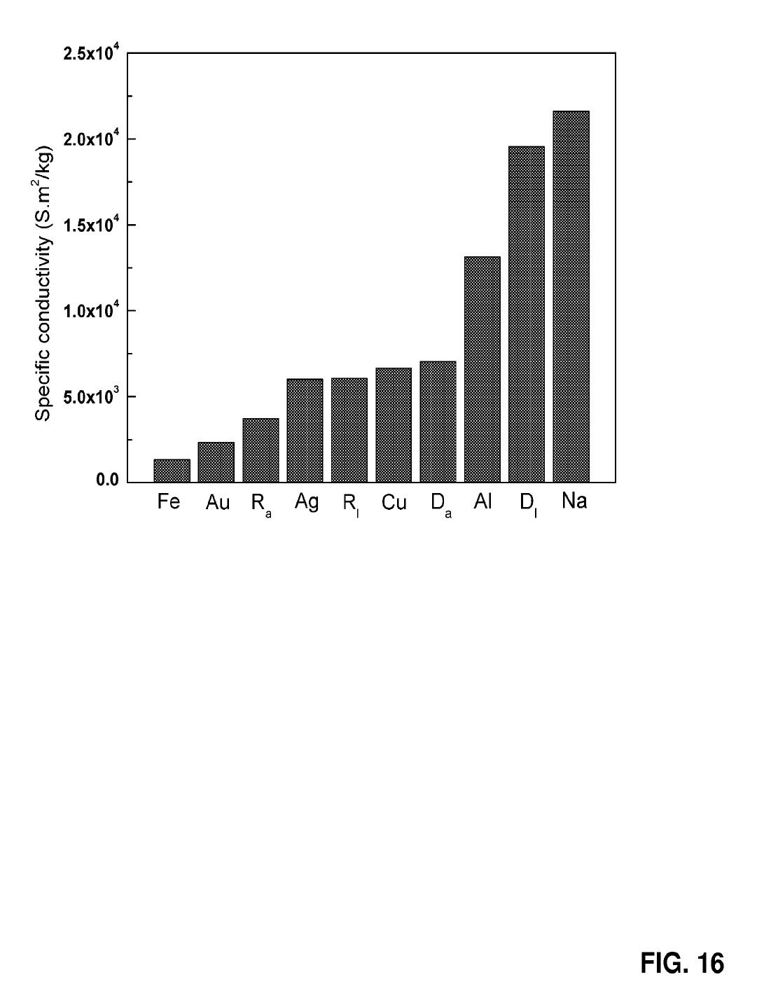

We have measured the current carrying capacities of seven raw DWCNT fibers and seven iodine doped DWCNT fibers. The measured current carrying capacities of these fibers range from about 10⁴ A/cm² to about 10⁵ A/cm². FIG. 17 illustrates a comparison in current carrying capacities between DWCNT fibers and copper wires for household use. DWCNT fibers' current carrying capacity is 100-1000 times larger than copper at the comparable scale.

Without being bound by theory, such observations imply that the macroscopic fibers are broken at the interconnections between nanotubes when a high current is passing through, even if each carbon nanotube is intact. Although macroscopic fibers don't have a current carrying capacity as high as single carbon nanotubes, they still have a sufficiently high current carrying capacity to be able to load utilities with a small dimension.

### Example 9

### Electrical Properties of Assembled DWCNT Fibers

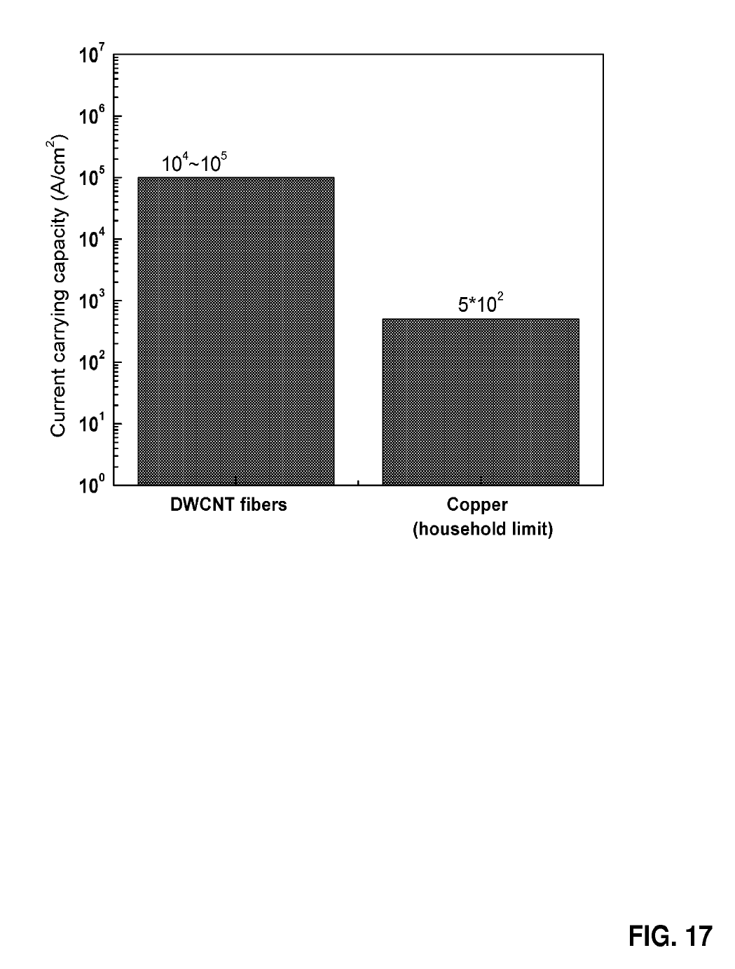

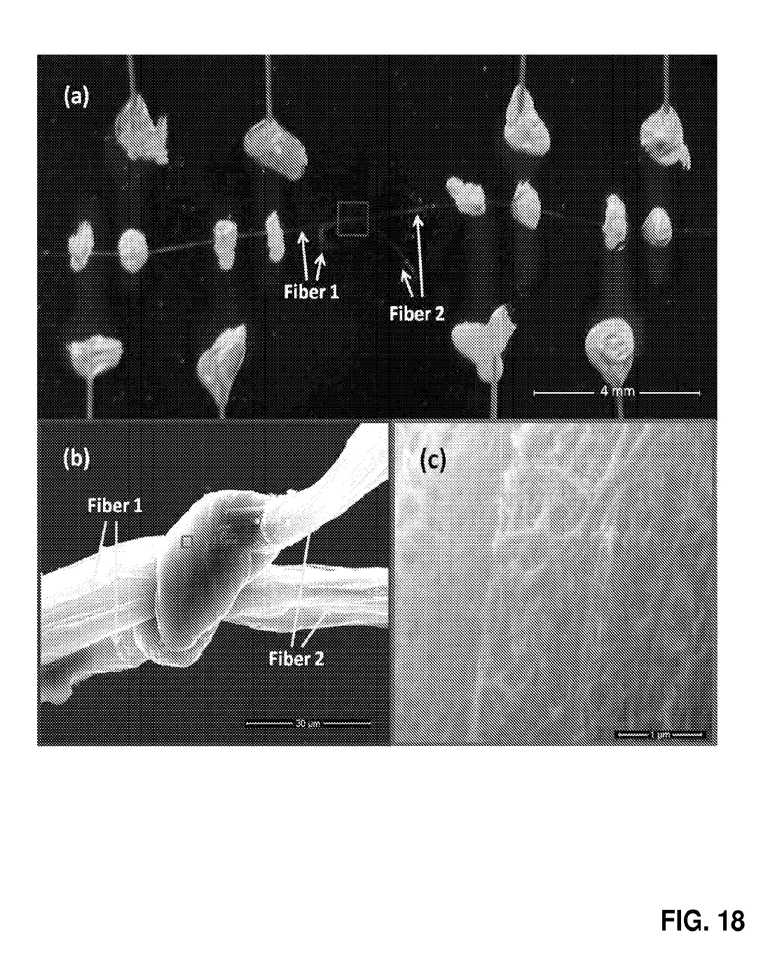

Applicants also elucidated the relation between the electrical properties of assembled DWCNT fibers and its components. FIG. 18 provides an illustration of the assembled DWCNT fibers utilized in the study. As shown in FIG. 18A, fiber 1 and fiber 2 are linked by a tie. A four electrode setup was applied for the I-V curve measurement. The contacts were silver paste. The electrodes were gold fingers deposited on the silicon dioxide substrate. FIG. 18B shows the SEM image of the tie. Fiber 1 and fiber 2 have diameters of 13 microns and 11.5 microns, respectively. FIG. 18C is a zoom-in view of the tie. In this assembly, the DWCNTs have an alignment in the long axial direction of the fiber.

Serial Connection

Two fibers (fiber 1, diameter=13 microns; fiber 2, diameter=11.5 microns) were linked by a tie, as shown in FIG. 18. In this Example, the tie was made by a micromanipulator.

The resistivity of fiber 1 and 2 individually were 9.6*10⁻⁵ ohm.cm and 9.35*10⁻⁵ ohm.cm. Based on the resistivity, diameter and length of each fiber (length is for the segment between the electrode finger and the tie), we can calculate the resistance of fiber 1 and fiber 2 as 15.33 ohm and 16.34 ohm, respectively. The resistance of the assembled structure containing fiber 1, fiber 2 and the tie is 31.9 ohm. The resistance from the tie is singled out as 0.23 ohm. This finding indicates that no significant resistance would be introduced by the tie when several short fibers are assembled into a long one.

Parallel Connection

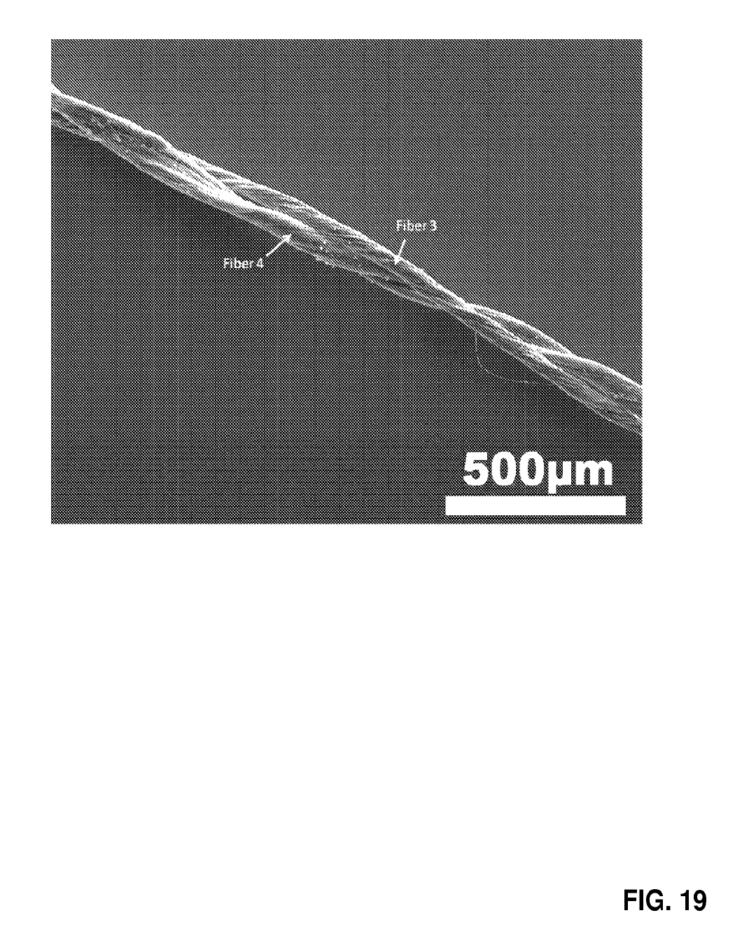

Two parallel DWCNT fibers (fibers 3 and fiber 4) were twisted into one, as shown in FIG. 19. Before the twisting, fiber 3 and fiber 4 had a resistance of 24 ohm and 20 ohm, respectively. Theoretically, the assembled thick fiber of fiber 3 and 4 in a parallel configuration should have a resistance of 10.9 ohm (R_{theoretical}=(R₃*R₄)/(R₃+R₄)). From measurement, we found that the assembled thick fiber had a resistance of 10.5 ohm, which is even smaller than the theoretical value. Without being bound by theory, it is envisioned that this difference might be due to the twisting, which renders each fiber more densely packed, thereby decreasing the resistance of each fiber. Such observations indicate that fibers in the present invention can be assembled in various forms without losing significant conductivity.

### Example 10

### Thermal Resistance of DWCNT Fibers

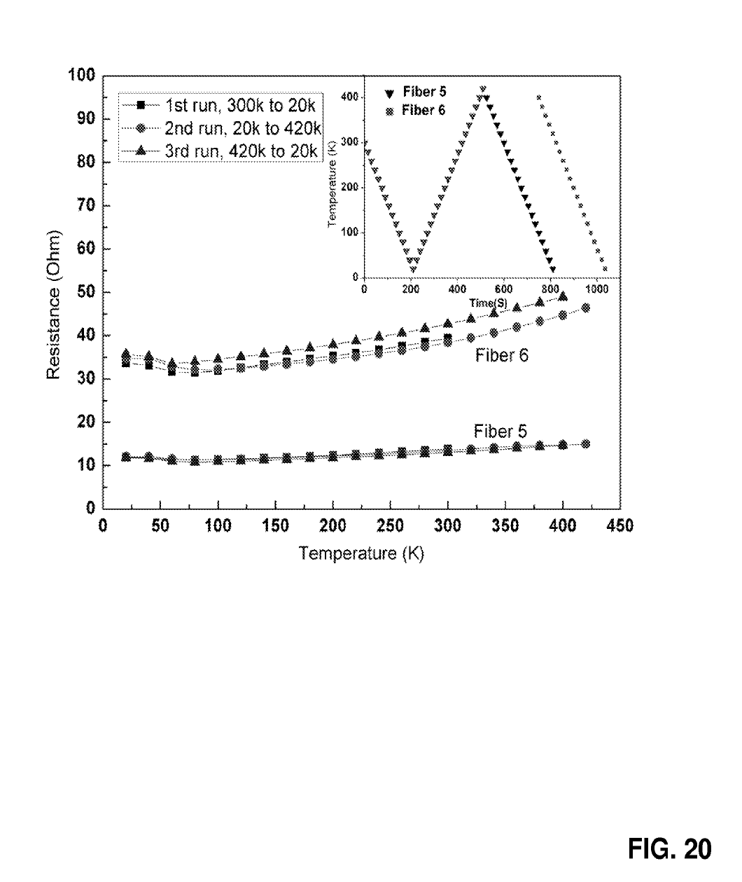

The resistance of iodine doped DWCNT fibers was measured as a function of temperature. Two data acquisition protocols as shown in the inset of FIG. 20 were implemented. For one protocol, the electrical measurement was conducted for every 15 minutes, during which the temperature changed by 20 k and stabilized at the targeted value. In the 1^{st} run, the sample was cooled down from the room temperature to 20 k. In the 2^{nd} run, the sample was ramped up from 20 k to 420 k, continuously followed by the 3^{rd} run, in which the sample was cooled down from 420 k to 20 k. The major difference between the second protocol and the first protocol is that the measurement was paused for 4 hours after the resistance measurement was completed at 420 k. The purpose is to test the stability of the iodine doped fiber at the high temperature for a longer time. The curve of the resistance as a function of temperature for fiber 5 is repeatable during the cyclic thermal treatment. By contrast, the room temperature resistance of fiber 6 increases by 9% after the stay at 420 k for 4 hours. This increase might be due to the iodine loss by the 4 hours of heating. In the real experiment, we have measured more than two fibers. Fibers 5 and 6 are two representative DWCNT fibers, which can show the typical resistance change of iodine doped fiber by different heat treatments.

Variation of Resistivity in the Range of the Operation Temperature

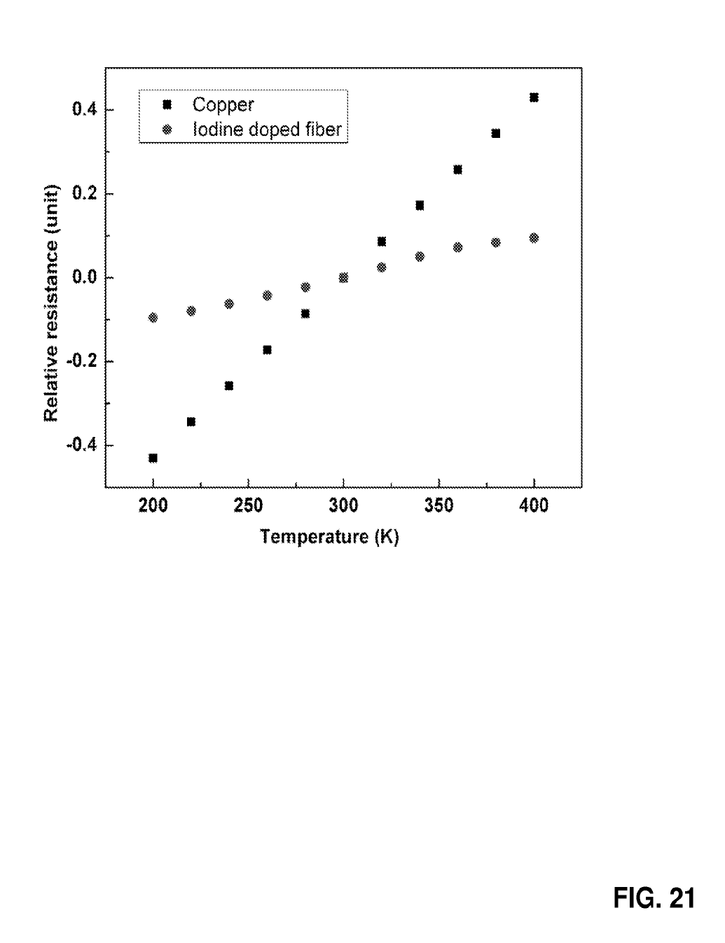

As the materials used in engineering components, the performance stability over a wide temperature range is important. DWCNT fibers were studied for the application as the conducting wires. Copper is the most commonly used raw material for the conducting wires. In this study, we compared the relative resistance (the relative resistance is defined by (R−R_room)/R_room, where R is the measured resistance and R_room is the room temperature resistance) of iodine doped DWCNT fibers with that of copper in the temperature range from 200 k to 400 k (+, −100 k from the room temperature). As shown in FIG. 21, the relative resistance versus temperature curves of copper and iodine doped DWCNT fibers both are linear from 200 k to 400 k. The resistance variation of the iodine doped DWCNT fiber between 200 k and 400 k is 9%. By contrast, the corresponding variation of copper is 43%. This indicates that iodine doped DWCNT fibers show less variation in resistance at different temperatures.

### Example 11

### Effect of Polymers on DWCNT Fiber Conductivity

An epoxy coating was applied onto the DWCNT fibers via dip coating. This was followed by a curing step. The conductivity of the DWCNT fibers only had a slight decrease of about 10% as a result of the coating. This indicates that DWCNT fibers that are coated with polymers may be used in the present invention.

### Example 12

### Fabrication of Products

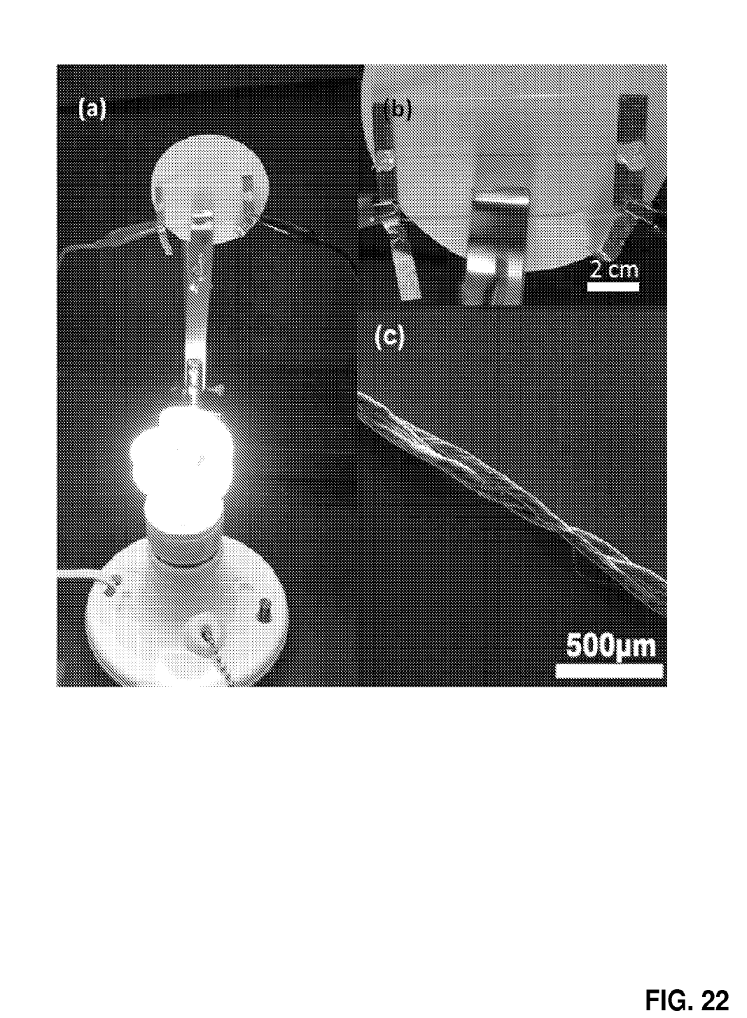

In this Example, it is demonstrated that a braided wire of two iodine doped DWCNT fibers can be used as a conducting wire in a household circuit. A household light bulb (9 watts, 0.15 A, 120V) was connected with the power supply through the braided wire. The light bulb was powered on. The power remained on for 3 days. As illustrated in FIG. 22, the circuit functioned well during the whole testing period.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A carbon nanotube fiber comprising:
one or more fiber threads,
wherein the one or more fiber threads comprise multi-walled carbon nanotubes, and wherein the multi-walled carbon nanotubes are doped with one or more dopants.

2. The carbon nanotube fiber of claim 1, wherein the multi-walled carbon nanotubes comprise double-walled carbon nanotubes.

3. The carbon nanotube fiber of claim 1, wherein the multi-walled carbon nanotubes consist essentially of a single type of carbon nanotube.

4. The carbon nanotube fiber of claim 3, wherein the single type of carbon nanotube is a double-walled carbon nanotube.

5. The carbon nanotube fiber of claim 1, wherein the multi-walled carbon nanotubes are functionalized with functional groups, wherein the functional groups are selected from the group consisting of carboxyl groups, carbonyl groups, oxides, alcohol groups, phenol groups, and combinations thereof.

6. The carbon nanotube fiber of claim 1, wherein the dopant is selected from the group consisting of iodine, silver, chlorine, bromine, fluorine, gold, copper, aluminum, sodium, iron, antimony, arsenic, and combinations thereof.

7. The carbon nanotube fiber of claim 1, wherein the dopant comprises iodine.

8. The carbon nanotube fiber of claim 1, wherein the dopant comprises antimony pentafluoride.

9. The carbon nanotube fiber of claim 1, wherein the carbon nanotube fiber comprises a plurality of intertwined fiber threads that are twisted in a parallel configuration with one another.

10. The carbon nanotube fiber of claim 1, wherein the carbon nanotube fiber comprises a plurality of fiber threads that are tied to one another in a serial configuration.

11. The carbon nanotube fiber of claim 1, wherein the carbon nanotube fiber has a length of about 5 microns to about 100 microns, and a diameter of less than about 10 μm.

12. The carbon nanotube fiber of claim 1, wherein the carbon nanotube fiber has a current carrying capacity of at least about 10⁴ A/cm² to about 10⁵ A/cm².

13. The carbon nanotube fiber of claim 1, wherein the carbon nanotube fiber has a resistivity of less than about 0.05 m m.Ω.cm.

14. The carbon nanotube fiber of claim 1, wherein the carbon nanotube fiber is coated with a polymer, wherein the polymer is selected from the group consisting of polyethylenes, polypropylenes, poly(methyl methacrylate) (PMMA), polyvinyl alcohols (PVA), epoxide resins, and combinations thereof.

15. The carbon nanotube fiber of claim 1, wherein the carbon nanotube fiber is in the shape of a cable or a wire.

16. A method of making a carbon nanotube fiber, comprising:
growing multi-walled carbon nanotubes;
purifying the multi-walled carbon nanotubes;
aggregating the multi-walled carbon nanotubes, wherein the aggregating forms one or more fiber threads; and
doping the multi-walled carbon nanotubes with one or more dopants.

17. The method of claim 16, further comprising a step of functionalizing the multi-walled carbon nanotubes.

18. The method of claim 16, wherein the growing step occurs by chemical vapor deposition.

19. The method of claim 16, wherein the purifying step comprises exposing the multi-walled carbon nanotubes to an acidic solution.

20. The method of claim 16, wherein the aggregating step comprises shrinking the multi-walled carbon nanotubes, wherein the shrinking occurs by exposure of the multi-walled carbon nanotubes to deionized water.

21. The method of claim 16, wherein the doping step occurs after the aggregating step.

22. The method of claim 16, wherein the doping step comprises sputtering the multiwalled carbon nanotubes with one or more dopants.

23. The method of claim 16, wherein the doping step occurs in situ during the growing step.

24. The method of claim 16, wherein the dopant comprises iodine.

25. The method of claim 16, wherein the dopant comprises antimony pentafluoride.

26. The method of claim 16, further comprising a step of linking formed fiber threads to one another.

27. The method of claim 26, wherein the linking comprises twisting the fiber threads to one another to form a parallel configuration.

28. The method of claim 26, wherein the linking comprises tying the fiber threads to one another to form a serial configuration.

29. The method of claim 26, wherein the linking leads to the formation of cables or wires.

30. The method of claim 16, further comprising a step of coating the carbon nanotube fiber with a polymer, wherein the polymer is selected from the group consisting of polyethylenes, polypropylenes, poly(methyl methacrylate) (PMMA), polyvinyl alcohols (PVA), epoxide resins, and combinations thereof.

31. The method of claim 16, wherein the multi-walled carbon nanotubes consist essentially of a single type of carbon nanotube.

32. The method of claim 31, wherein the single type of carbon nanotube is a double-walled carbon nanotube.
